(19) United States
(12) Patent Application Publication
(10) Pub. No.: US 2021/0164867 A1
(43) Pub. Date: Jun. 3, 2021

(54) METHOD FOR POSITIONING AT LEAST ONE WHEEL HOLDER OF A VEHICLE TEST BENCH

(71) Applicant: DÜRR Assembly Products GmbH, Saarbrücken (DE)

(72) Inventors: Christoph Heinz, Saarbrücken (DE); Sacha Arend, Dalem (DE); Thomas Kolb, Blieskastel (DE); Thomas Tentrup, Merzig-Mechern (DE); Bernd Pasker, Püttlingen (DE)

(21) Appl. No.: 16/641,491

(22) PCT Filed: Aug. 24, 2018
(86) PCT No.: PCT/DE2018/100735

§ 371 Date: Feb. 24, 2020

(30) Foreign Application Priority Data
Aug. 25, 2017 (DE) 10 2017 119 583.1

(51) Int. Cl. G01M 17/007

(52) U.S. Cl. CPC G01M 17/0074

(57) ABSTRACT

The present invention relates to a method of positioning at least one wheel support of a vehicle dynamometer in relation to the position of a wheel in the longitudinal direction of a vehicle standing on the vehicle dynamometer. The wheel support is positioned using a drive unit for adjusting the position of the wheel support. The positioning takes place with a vehicle located on the vehicle dynamometer, wherein the vehicle is held in place during the positioning at least in relation to its longitudinal direction. The positioning of the wheel support takes place as a function of a variable that represents
a three to be applied by the drive unit and/or
a torque to be applied by the drive unit and/or
the power consumption of the drive unit and/or
the work done by the drive unit when the wheel support is moved along a defined distance when a specific movement profile of the wheel support is achieved during movement in a direction corresponding to the longitudinal direction of a vehicle standing on the vehicle dynamometer.

### PRIOR APPLICATIONS

The present application claims priority as a national patent application to PCT/DE2018/100735, filed on Aug. 24, 2018, which claims priority German Patent Application No. 102017119583 filed on Aug. 25, 2017, the contents each of which are incorporated herein in their entirety.

### TECHNICAL FIELD

The present invention relates to a method of positioning at least one wheel support of a vehicle dynamometer in relation to the position of a vehicle wheel according to the preamble of claim 1.

### BACKGROUND

It is known to provide wheel supports having twin rollers in vehicle dynamometers. In this case, the vehicle wheel sinks down between the two rollers. At least one of the two rollers can be driven or braked in order to be able to transmit forces to the corresponding wheel of the vehicle. It is also possible to switch both rollers of the wheel support to the freewheeling mode.

Wheel supports are also known that are configured as single rollers. In the case of these wheel supports, the wheel of the vehicle ideally stands on the upper apex of the single roller. The position of the wheel is metastable in this position. To stabilize the position of the wheel, two additional support rollers are provided, which are in contact with the outer circumference of the wheel on both sides, relative to the line of contact of the wheel on the single roller, and stabilize the position of the wheel.

In a vehicle dynamometer, both wheel supports having twin rollers and wheel supports having a single roller can be provided for multi-axle vehicles.

The positioning of the at least one wheel support takes place in the longitudinal direction of a vehicle standing on the vehicle dynamometer based on the position of at least one wheel of an axle.

This positioning is intended to adjust the vehicle dynamometer to the wheelbase of the two-axle vehicle to be tested in each case. This makes it possible to adjust the vehicle dynamometer for different vehicle models with different wheelbases.

It is likewise possible, therefore, to adjust it to the wheelbases of multi-axle vehicles. In the case of trucks specifically, this proves useful because it is standard practice here to keep the position of the individual vehicle axles in the longitudinal direction of the vehicle flexible and to adjust the position of the axles of the individual vehicles in the longitudinal vehicle direction according to the requirements to which the vehicle is subject in each case.

For these reasons, it is known to assign a drive unit to the at least one wheel support, with which drive unit the adjustment of the wheel support's position is accomplished.

In known vehicle dynamometers, this takes place by advance positioning of the wheel supports in the vehicle dynamometer before a vehicle drives on to the vehicle dynamometer. To this end, the wheelbase or wheelbases of the next vehicle to enter the vehicle dynamometer is/are transmitted to the control unit of the vehicle dynamometer. This makes it possible to set up the vehicle dynamometer in advance.

From JP 2013 195316 A, an embodiment of a wheel support is known, which consists of a single roller and two support rollers. The wheel of a vehicle is positioned using the two support rollers such that it is centered on the apex of the single roller and is held there. To make it easier to drive the vehicle on and off the single roller, the support rollers are foldable. This enables the support rollers to be folded into a lower position, so that the vehicle can drive on to or off the single roller.

DE 10 2004 010 072 A1 describes a method of testing whether the handbrake of a vehicle has been applied. To this end, a wheel of the vehicle is gripped from the outside using a gripping device and the vehicle is then moved in the longitudinal direction of the vehicle by a movement of the gripping device. The force needed for this movement is measured in order to derive therefrom whether the vehicle's handbrake is applied or released.

### SUMMARY

The present invention is intended to enable a better adjustment of the position of the at least one wheel support to the position of the respective vehicle axle. Furthermore, the wheel supports can be adjusted to the positions of axles if these axle positions are not known with sufficient accuracy or if the information about the axle positions is not known.

This object is achieved according to the present invention in that the positioning takes place with a vehicle located on the vehicle dynamometer. The vehicle is held in place during positioning, at least in relation to its longitudinal direction. The positioning of the wheel support takes place as a function of a variable that represents

a force to be applied by the drive unit and/or

a torque to be applied by the drive unit and/or

the power consumption of the drive unit and/or

the work done by the drive unit when the wheel support is moved along a defined distance

when a specific movement profile of the wheel support is achieved during movement in a direction that corresponds to the longitudinal direction of a vehicle standing on the vehicle dynamometer.

The invention is based on the fact that the aforementioned variable exhibits a minimum in its profile (if the wheel support is a twin roller) or a maximum (if the wheel support is a single roller) during the movement of the wheel support. This is because, when the wheel support moves, potential energy is reduced when the vehicle sinks down further as a result of the movement of the respective wheel support in the longitudinal vehicle direction, or potential energy is increased, i.e. energy has to be applied in order to raise the vehicle via its wheels and axle when the respective wheel support moves in the longitudinal vehicle direction.

In the case of twin rollers, the respective wheel is in the lowest position when this wheel is located precisely centrally between the two rollers. In the case of a single roller, the respective wheel is in the highest position when this wheel stands precisely on the apex of the single roller.

If, in the case of twin rollers, the wheel support is moved relative to the wheel of the vehicle in the longitudinal vehicle direction towards the described optimum position between the two rollers, the lowering of the wheel assists the movement of the wheel support. The aforementioned variable therefore decreases until the optimum position is reached. If the wheel support is moved relative to the wheel of the vehicle beyond this optimum position, the variable increases again because the wheel then has to be raised again.

If, in the case of a single roller, the wheel support is moved relative to the wheel of the vehicle in the longitudinal vehicle direction towards the described optimum position, at which the wheel stands on the apex of the single roller, the variable increases until the optimum position has been reached because the wheel has to be raised in this case. If the wheel support is moved relative to the wheel of the vehicle beyond this optimum position, the variable decreases again because the wheel then falls again so that the potential energy is decreased.

It is essential in this case that the vehicle is held in place in the longitudinal direction. Otherwise, it can happen that a displacement of the wheel support in the longitudinal direction of the vehicle results in a displacement of the vehicle in the longitudinal vehicle direction instead of raising the wheel. The securing of the vehicle can take place by the sinking of at least one axle into a fixed wheel support with twin rollers. It is likewise possible to provide holding elements (bumpers) which are in contact with the vehicle and which prevent movement of the vehicle in the longitudinal direction.

The specific movement profile of the wheel support is, in the simplest case, a uniform movement of the wheel support in the longitudinal direction of the vehicle at a constant speed. In this case, only the sliding friction of the wheel support, the friction of the rollers or roller and the friction of the wheel on the vehicle axle during the movement are relevant. It is a prerequisite here that the wheel or the roller(s) can rotate freely. Apart from the change in potential energy, no components of the force or power or work that cause an acceleration or deceleration in the movement of the wheel support have to be taken into account. By the movement of the wheel support at uniform speed, the variable can be readily evaluated over the course of the wheel support's movement in the longitudinal vehicle direction. If the wheel support is set in motion, adhesive friction first has to be overcome. It would therefore involve more effort to evaluate the signal of the variable over the course of the movement of the wheel support if the wheel support were repeatedly stopped over the course of the movement and then set in motion again.

Where the wheel support has a lifting device to raise the respective wheel of a vehicle standing on the wheel support when driving it off the vehicle dynamometer, this lifting device must be in the lowered position in the method according to the present invention. However, such a lifting device is not absolutely necessary. It is also known, in the case of a wheel support consisting of twin rollers, to make it easier to drive off the vehicle by positioning these twin rollers with a minimum spacing of the axes of the twin rollers. This raises the vehicle, thus making it easier to drive off the wheel support. These twin rollers can be positioned with a larger spacing of their axes for performing testing, measuring and/or adjustment work. This causes the corresponding wheel of the vehicle to sink further down in order to prevent the vehicle from being unintentionally lifted off or driven off while the testing and/or measuring work is being performed. The flexible positioning of the spacing of the two rollers also serves to adjust the wheel support as a function of the vehicle's ground clearance so that the vehicle does not rest on the dynamometer.

In the embodiment of the method according to claim 2, the wheel support has twin rollers. The position of the wheel support is adjusted as a function of an identified minimum of the variable during a movement of the wheel support in a range in which a wheel of the vehicle is located between the two rollers of the wheel support.

In the embodiment of the method according to claim 3, the wheel support has a single roller. The position of the wheel support is adjusted as a function of an identified maximum of the variable during a movement of the wheel support in the longitudinal vehicle direction in a range in which a wheel of the vehicle stands on the single roller.

The conditions for the procedures according to claims 2 and 3 have already been explained in connection with claim 1.

It can be simpler for signal evaluation here to perform a movement of the wheel support over a range with a greater distance on both sides of the position of the wheel support at which the variable exhibits its minimum (twin roller) or maximum (single roller). This position will be referred to below as the “target position”. If the signal profile of the variable obtained when the wheel support is moved away from the target position and towards the target position respectively is compared in each case here, the signal profile—particularly also in terms of the gradient obtained in the signal profile of the variable—can be compared in the two ranges ahead of and behind the target position respectively in the longitudinal vehicle direction. This proves advantageous particularly in the case of a single roller because there, owing to the profile of the surface in the region of the maximum in the signal profile of the variable, rather a shallow gradient is obtained. Thus, the position of the maximum in the signal profile is harder to measure. With a greater distance of the wheel support from this target position, a steeper rise is shown in the signal profile of the variable when the wheel support is moved towards the target position. This is because the respective wheel is raised to a greater degree if this wheel is located at a greater distance from the apex in the case of a single roller (provided that the wheel is still standing on the single roller). If, therefore, the rise in the signal profile is evaluated at a greater distance from the target position, the target position can be determined with better accuracy by forming an average of the position at the values of the rise in the signal profile on both sides of the target position. Advantageously here, either the two signal profiles are compared when the wheel support is moved towards the target position or the two signal profiles are compared when the wheel support is moved away from the target position.

In the embodiment according to claim 4 the drive unit is an electric motor. The variable is the power consumption of the electric motor.

This proves advantageous insofar as this variable is simple to measure without the need to provide an additional force sensor.

In principle, instead of the electric motor, another drive unit can also be used. The force measurement can also take place by another method, e.g. using a load cell.

### BRIEF DESCRIPTION OF THE DRAWINGS

In the drawings, the conditions during the movement of the wheel support in the longitudinal direction are illustrated again for explanatory purposes. The figures show the following:

FIG. 1: a schematic diagram of a wheel support as a twin roller with a vehicle wheel standing on one of the two rollers,

FIG. 2: a schematic diagram of the wheel support as a twin roller according to FIG. 1 with a vehicle wheel standing on the other of the two rollers,

FIG. 3: a force profile of a drive unit for moving the wheel support from the position of FIG. 1 to the position of FIG. 2,

FIG. 4: a schematic diagram of a wheel support as a single roller with a vehicle wheel standing on one side of the single roller,

FIG. 5: a schematic diagram of the wheel support as a single roller according to FIG. 4 with a vehicle wheel standing on the other side of the single roller,

FIG. 6: a force profile of a drive unit for moving the wheel support from the position of FIG. 4 to the position of FIG. 5.

### DETAILED DESCRIPTION

FIG. 1 shows a schematic diagram of a wheel support 1 as a twin roller 2, 3 with a vehicle wheel 4 standing on one of the two rollers 3.

The conditions for the movement of the wheel support 1 relative to the vehicle wheel 4 are explained with the aid of a movement of the wheel support 1 in the direction of the arrow 5 relative to the position of the vehicle wheel 4.

During this movement the wheel initially sinks down between the two rollers 2, 3 of the wheel support 1. During the movement, the force needed to move the wheel support 1 in the direction of the arrow 5 decreases. Since the vehicle wheel 4 does not fall in a linear fashion compared to the movement of the wheel support in the direction of the arrow 5, the force curve is likewise non-linear.

When the wheel support 1 has been moved sufficiently far that the vehicle wheel 4 is located precisely between the two rollers 2, 3 in the longitudinal direction, the vehicle wheel 4 is at its lowest.

During a further movement of the wheel support in the direction of the arrow 5 relative to the vehicle wheel 4, the vehicle wheel 4 is raised again. As a result thereof, the force needed to drive the wheel support 1 increases again, until the vehicle wheel 4 stands on the upper apex of the roller 2.

FIG. 2 shows a schematic diagram of the wheel support 1 as a twin roller 2, 3 according to FIG. 1 with a vehicle wheel standing on the other of the two rollers 2. The wheel support 1 has accordingly been moved further in the direction of the arrow 5.

FIG. 3 shows the force profile of a drive unit for moving the wheel support 1 from the position of FIG. 1 to the position of FIG. 2.

It can be seen that the three initially falls and, when the lowest point of the vehicle wheel 4 is passed, it rises sharply. The range of interest in the force profile during the movement of the wheel support here (transition between the positions: “vehicle wheel 4 stands on the upper apex of the roller 3” and “vehicle wheel 4 stands on the upper apex of the roller 2”) is marked on the curve of the force profile such that this range of interest lies between the two marks on the curve profile of FIG. 3.

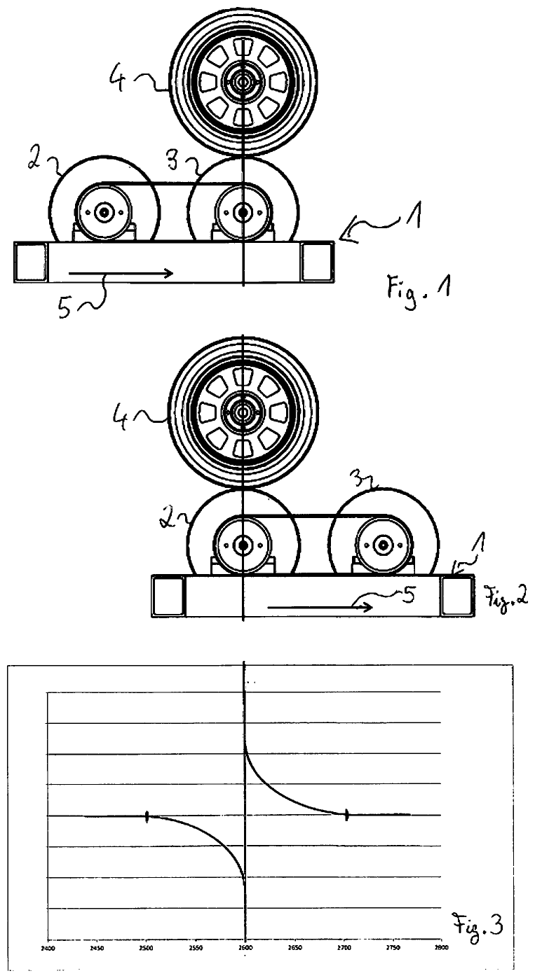

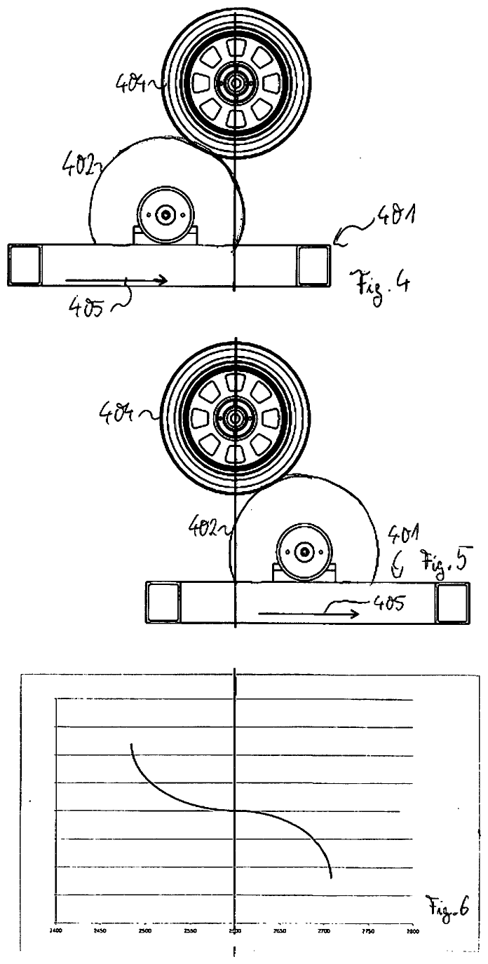

FIG. 4 shows a schematic diagram of a wheel support 401 as a single roller 402 with a vehicle wheel 404 in contact with the single roller 402 on the “right-hand” side (in the illustration of FIG. 4).

The conditions of the movement of the wheel support 401 relative to the vehicle wheel 404 are explained with the aid of a movement of the wheel support 401 in the direction of the arrow 405 relative to the position of the vehicle wheel 404.

During this movement the wheel 404 is initially raised until the wheel stands on the upper apex of the single roller 402. During the movement, the force needed to move the wheel support 401 in the direction of the arrow 405 increases. Since the vehicle wheel 404 does not rise in a linear fashion compared to the movement of the wheel support 401 in the direction of the arrow 405, the force curve is likewise non-linear.

When the wheel support 401 has been moved so far that the vehicle wheel 404 stands on the apex of the single roller 402, the vehicle wheel 404 is at its highest.

During a further movement of the wheel support 401 in the direction of the arrow 405 relative to the vehicle wheel 404, the vehicle wheel 404 sinks down again. As a result of this, the force needed to drive the wheel support 401 decreases.

FIG. 5 shows a schematic diagram of the wheel support 401 as a single roller 402 with a vehicle wheel 404 in contact with the single roller 402 on the “left-hand” side (in the illustration of FIG. 5). The wheel support 401 has accordingly been moved further in the direction of the arrow 5, based on the illustration of FIG. 4.

FIG. 6 shows the force profile of a drive unit for moving the wheel support 401 from the position of FIG. 4 to the position of FIG. 5.

It can be seen that the force initially falls to an inflection point in the curve of the force profile and then falls further. The inflection point here corresponds to the position of the wheel support 401 at which the vehicle wheel 404 stands on the apex of the single roller 402.

Since in the case of a single roller the vehicle wheel changes its position in a vertical direction less in the region immediately surrounding the apex during a displacement of the single roller relative to the vehicle wheel than at a greater distance from this apex, it can be useful in the case of a single roller to determine the position at which the vehicle wheel 404 stands on the apex of the single roller 402 by evaluating a larger section of the force profile.

The curve profile of FIG. 6 can be explained by the fact that, during a movement of the vehicle wheel 404 towards the apex, when the wheel support is displaced by a specific distance the vehicle wheel must be raised by a larger amount at a greater distance from the apex than at a closer distance during a movement of the vehicle wheel towards the apex. During a movement away from the apex, the same applies to the lowering of the vehicle wheel.

1. A method of positioning at least one wheel support (1; 401) of a vehicle dynamometer in relation to the position of a wheel (4; 404) in the longitudinal direction of a vehicle standing on the vehicle dynamometer, wherein the wheel support (1; 401) has a single roller (402) or a twin roller (2, 3), wherein the wheel support (1; 401) is positioned using a drive unit for adjusting (5; 405) the position of the wheel support (1; 401),
characterized in that the positioning takes place with a vehicle located on the vehicle dynamometer, wherein the vehicle is held in place during the positioning, at least in relation to its longitudinal direction, wherein the positioning of the wheel support (1; 401) takes place as a function of a variable that represents
a force to be applied by the drive unit and/or
a torque to be applied by the drive unit and/or
the power consumption of the drive unit and/or
the work done by the drive unit when the wheel support (1; 401) is moved along a defined distance
when a specific movement profile of the wheel support (1; 401) is achieved during a movement (5; 405) in a direction corresponding to the longitudinal direction of a vehicle standing on the vehicle dynamometer.

2. The method according to claim 1,
characterized in that the wheel support (1) has a twin roller (2, 3) and in that the position of the wheel support (1) is adjusted as a function of an identified minimum of the variable during a movement of the wheel support (1) in a range in which a wheel (4) of the vehicle is located between the two rollers (2, 3) of the wheel support (1).

3. The method according to claim 1,
characterized in that the wheel support (401) has a single roller (402) and in that the position of the wheel support (401) is adjusted as a function of an identified maximum of the variable during a movement of the wheel support (401) in a range in which a wheel (404) of the vehicle stands on the single roller (402).

4. The method according to one of claims 1 to 3,
characterized in that the drive unit is an electric motor and in that the variable is the power consumption of the electric motor.
